(19) United States
(12) Patent Application Publication
(10) Pub. No.: US 2018/0068006 A1
(43) Pub. Date: Mar. 8, 2018

(54) SYSTEM AND METHOD FOR COMPUTER PROGRAMMING

(71) Applicant: Aquameta LLC, Portland, OR (US)

(72) Inventor: Eric Hanson, Portland, OR (US)

(21) Appl. No.: 15/132,100

(22) Filed: Apr. 18, 2016

Related U.S. Application Data
(60) Provisional application No. 62/148,741, filed on Apr. 16, 2015.

(51) Int. Cl. G06F 17/30; G06F 9/45; G06F 9/44

(52) U.S. Cl. CPC G06F 17/30595; G06F 8/71; G06F 8/40

(57) ABSTRACT

A method for referencing database components of a relational database includes the steps of selecting a relational database with components, and referencing the components as typed relational data within the database itself. A method of using a writable system catalog with meta-identifiers for a relational database includes the steps of selecting a relational database with components, using meta-views to expose the components of the relational database as data, and to identify them by a meta-identifier, and employing triggers for each meta-view, to enable INSERT, UPDATE and DELETE operations on them, to translate the DML (data manipulation language) operation into a DDL (data definition language) operation, and to execute the DDL operation. A method of version control using bundle-data and meta-data, includes the steps of selecting a relational database that includes data, schema, and an historical archive of the state of arbitrary rows and arbitrary states of the database schema, and managing the historical archive by using meta-identifiers and a writable system catalog.

### CROSS-REFERENCE TO RELATED APPLICATIONS

This application claims priority to U.S. Provisional Patent Application Ser. No. 62/148,741, filed Apr. 16, 2015 and entitled “System and Method for Computer Programming”, the disclosure of which is incorporated herein by reference.

### DETAILED DESCRIPTION

The invention is described below and in Attachment A.

I. Meta-Identifier System for Referencing the Components of a Relational Databases

One feature of the invention is a meta-identifier system for referencing the components of a relational databases from within the database itself, as typed relational data. The components of a relational database vary from database to database, depending on the database's features and compliance to the SQL standard. The list of “components” could include SCHEMA, TABLE, VIEW, RELATION, COLUMN, ROW, FIELD, CAST, TYPE and OPERATOR. They could also include other database components like ROLE, PRIVILEGE, FOREIGN SERVER, etc.

For each component, the meta-identifier system provides:

A) Identifier Type

A meta-identifier TYPE, whose name is the component name followed by “_id”, e.g. “column” to “column_id”, and whose purpose is to make references to instances of this meta-component. Internally this type is composed of a combination of the component's name, and other meta-identifiers required to disambiguate the component from others of the same name.

### Example:

CREATE TYPE column_id (relation_id meta.relation_id, name text);

B) Constructor Function

A constructor FUNCTION which takes named arguments and returns a new instance of that identifier.

### Example:

CREATE FUNCTION meta.column_id(schema_name text, relation_name text, name text)
RETURNS meta.column_id AS $$ SELECT row(row(row(schema_name), relation_name), name):meta.column_id; $$ LANGUAGE sql;

C) Casts to Other Meta-Identifiers

From this meta-identifier to any other less-specific meta-identifiers that are implied, if any. For example a column_id can be cast to a schema_id because a column_id contains a schema_id as part of its internal makeup.

### Example:

CREATE FUNCTION column_id_to_relation_id(IN meta.column_id, OUT meta.relation_id) AS $$ SELECT $1.relation_id $$ LANGUAGE sql; CREATE CAST (column_id AS relation_id) WITH FUNCTION column_id_to_relation_id(column_id) AS ASSIGNMENT;

D) Comparator with Json Type

A comparator OPERATOR and equality FUNCTION for comparing a JSON object to a meta-identifier type, for comparing the meta-identifier to JSON data

E) Constructor from Json Type

Converts the identifier to a JSON object of corresponding structure.

### Example:

create function meta.column_id(value json) returns meta.column_id as $$ select row(row(row(value->‘relation_id’->‘schema_id’->>‘name’), value->‘relation_id’->>‘name’), value->>‘name’):meta.column_id $$ immutable language sql;

F) Cast to Json Type

create cast (json as meta.column_id) with function meta.column_id(json) as assignment;

The above feature of the invention allows a database schema designer to create columns of these data types, similar to foreign keys, but rather than referencing a row, it references a database “component”.

The traditional way to reference a database component would be to include the name of each field of the component in the referencing field. This is highly cumbersome because many database components (such as a field) require numerous fields to identify the component. For example a field's identifier includes the schema the field is in, the table the field is in, the name of the column the field is in, and the primary key of the row that the field is in. With meta-identifiers, a single data value can represent all of this information.

II. Writable System Catalog with Meta-Identifiers for a Relational Database

Another feature of the invention is a writable system catalog with meta-identifiers for a relational database, as described further below.

A) A set of meta-VIEWs that expose the components of a relational database as data, and identified by a “meta-identifier” (see IDF 0, meta-identifiers)

B) A set of TRIGGERS for each VIEW above, which enable INSERT, UPDATE and DELETE operations on them, translate the DML (data manipulation language) operation into a DDL (data definition language) operation, and executes the DDL operation.

The above writable VIEWs make it possible to manage the DDL components of relational database using only SELECT, INSERT, UPDATE and DELETE.

Advantages:

A) Simplify Database Admin

An all-data view of the database is simpler and more consistent.

B) Data-Centric Management

Typically the relational database is managed with the DDL, the “data definition language” which is a grammar for creating, modifying and deleting database components. The use of meta-identifiers enable single-key JOINs between tables. Without meta-identifiers, each view would need to have the names of all the components that make up its identification.

SELECT * FROM meta.column JOIN meta.relation r ON c.relation_id=r.id;

C) User Interface Building

The traditional approach to building a GUI to a relational database is to create an application that runs DDL commands in response to user input in the GUI. This approach is difficult because user input must be translated into DDL grammar statements, often necessitating complex string composition algorithms. With the meta system catalog, user interface interaction can instead generate data manipulation statements to the meta catalog, which it internally translates to DDL grammar statements. This presents a consistent, simple to use data interface for data management, drastically decreasing the complexity of GUI creation.

III. Bundle-Data and Meta-Data Version Control System

This feature of the invention enables a database user to version control both data and schema of a relational database. It also involves managing a historical archive of the state of arbitrary rows, and arbitrary states of the database schema in a relational database, using meta-identifiers and the writable system catalog (IDF0 and IDF1). This feature of the invention enables a developer to:

1. create “bundles” repositories for historical snapshots of arbitrary rows and meta-rows in a relational database;

2. “stage” changes between the previous commit and the state of the live database. When the database changes, it diverges from a previous commit. The stage is the place where the user specifies that they would like the change to be included in the next commit. The developer stages database changes in the following ways: a) stage the addition of a row to the commit, b) stage the deletion of a row from the previous commit, c) stage the modification of a field from the previous commit;

3. view the status of the stage in the head_db_stage view, which summarizes the difference (row adds, row deletes, field changes) between the previous commit, the working copy, and the stage;

4. View unstaged changes, changes to the live database which are available to be staged to the stage, deleted rows and modified fields;

5. View “untracked rows”, rows which are not a part of any bundle and are available to be added to the stage;

6. “ignore” database components, which excludes them from display in “untracked rows”. The developer can ignore meta-rows, which behave as follows: Ignoring a meta-table row ignores also the contents of that table. Ignoring a meta-schema row ignores all rows in all tables in that schema;

7. “commit” the stage to a new commit. Each bundle has a tree of commits. Each commit has a parent, and multiple commits can have the same parent. A commit is a snapshot of the values of arbitrary rows in the database. A commit is a materialized copy of the stage and a point in time, saved in the database;

8. “checkout” a commit. Checkout modifies the state of the database to match the contents of the commit, adding any new rows, deleting any removed rows, and modifying any fields. When a checkout is complete, the tracked rows in the database will be equal to the rows in the commit. Checkout happens in two stages. First, meta-rows are checked out, bringing the database schema into a state that is in sync with the state of the data in the commit. Second, data rows are checked out, inserting rows into potentially newly-created tables, and fields into potentially newly-created fields;

9. “push” a bundle's commits to a remote bundle. A bundle push transfers over the internet the commits that the remote bundle does not contain into that bundle. Bundle push can happen over numerous protocols, including WebRTC, http and psql;

10. “fetch” a remote bundle's commits into the local bundle. A fetch transfers any commits that the remote bundle has and the local bundle does not, and adds them to the local bundle's commits; and

11. Manage dependencies. When rows in a bundle's commit reference by foreign key rows that are not in that commit, it initiates a dependency. When checking out a commit, the bundle system checks for unsatisfied dependencies, and then checks other bundles for those dependencies. If such bundles exist, those bundles are automatically checked out as well.

Using this feature of the invention, multiple bundles can exist in a single database, tracking different rows, and co-existing at the same time. This feature of the invention also enables granular version management of data and schema of a relational database. It also allows the developer to: (i) choose a point in time when the database is in a state which is suitable for a commit, and then snapshotting and committing that state to the bundle; (ii) restore (“checkout”) a previous state of the tracked rows in the database; and (iii) transfer bundles from one database to another, and recreate changes made on one database in another.

The foregoing descriptions of embodiments of the present method and technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A method for referencing database components of a relational database, comprising:
selecting a relational database with components; and
referencing the components as typed relational data within the database itself.

2. A method of using a writable system catalog with meta-identifiers for a relational database, comprising:
selecting a relational database with components;
using meta-views to expose the components of the relational database as data, and to identify them by a meta-identifier; and
employing triggers for each meta-view, to enable INSERT, UPDATE and DELETE operations on them, to translate the DML (data manipulation language) operation into a DDL (data definition language) operation, and to execute the DDL operation.

3. A method of version control using bundle-data and meta-data, comprising:
selecting a relational database that includes data, schema, and an historical archive of the state of arbitrary rows and arbitrary states of the database schema;
managing the historical archive by using meta-identifiers and a writable system catalog.
